(19) United States
(12) Patent Application Publication
(10) Pub. No.: US 2019/0267671 A1
(43) Pub. Date: Aug. 29, 2019

(54) ELECTROLYTE AND SECONDARY LITHIUM BATTERY

(71) Applicant: CONTEMPORARY AMPEREX TECHNOLOGY CO., LIMITED, Ningde (CN)

(72) Inventors: Ming ZHANG, Ningde City (CN); Changlong HAN, Ningde City (CN); Cui ZHANG, Ningde City (CN); Xiaochong ZHOU, Ningde City (CN); Feng JU, Ningde City (CN)

(21) Appl. No.: 16/410,938

(22) Filed: May 13, 2019

Related U.S. Application Data
(63) Continuation of application No. PCT/CN2017/093745, filed on Jul. 20, 2017.

(30) Foreign Application Priority Data
Nov. 29, 2016 (CN) 201611073063.5

(51) Int. Cl. H01M 10/0567; H01M 10/0525

(52) U.S. Cl. CPC H01M 10/0567; H01M 2300/0025; H01M 10/0525

(57) ABSTRACT

The present disclosure provides an electrolyte and a secondary lithium battery. The electrolyte comprises a lithium salt, an organic solvent and an additive. The additive comprises fluoroborate and lithium difluorophosphate. When the electrolyte of the present disclosure is applied to the secondary lithium battery, the secondary lithium battery can have excellent high temperature cycle performance, high temperature storage performance, low temperature discharge performance and large rate charging performance at the same time, and low temperature lithium precipitation of the secondary lithium battery can be significantly inhibited.

### CROSS REFERENCE TO RELATED APPLICATION

This application is a continuation of PCT/CN2017/093745, filed on Jul. 20, 2017, which claims priority to Chinese Patent Application No. 201611073063.5 filed Nov. 29, 2016, which is incorporated herein by reference in its entirety.

### FIELD OF THE PRESENT DISCLOSURE

The present application relates to the field of battery technology, and more specifically relates to an electrolyte and a secondary lithium battery.

### BACKGROUND OF THE PRESENT DISCLOSURE

High energy density, long cycle life, wide range of operating temperature and green environmental protection of a lithium-ion secondary battery have made it become the main energy source of mobile electronic devices at present. In terms of user experience, people are demanding higher and higher requirements for charge and discharge rate, that is to say, the lithium-ion secondary battery needs to have large rate charge and discharge capability; in addition, they also propose higher demands on its environmental adaptability, because current electronic products sometimes need to be used under extreme conditions, such as very high temperature or very low temperature environment, in general, performance of the lithium-ion secondary battery is significantly deteriorated under extreme conditions compared to normal environment.

As an important part of the lithium-ion secondary battery, an electrolyte has great effect on charge and discharge rate performances, high and low temperature performances of the lithium-ion secondary battery. However, in general, it is contradictory to improve charge and discharge rate performances, low temperature discharge performance and high temperature performance of the lithium-ion secondary battery on basis of the electrolyte. On one hand, high temperature performance can be improved by adding a film forming additive to passivate interfaces of the positive electrode plate and negative electrode plate, but because interface resistances of the positive electrode plate and negative electrode plate are increased at the same time, charge and discharge rate performances and low temperature discharge performance of the lithium-ion secondary battery are significantly adversely affected. On the other hand, by optimizing constitute of an organic solvent to reduce viscosity of the electrolyte under low temperature and to improve conductivity, for example, by adding a large amount of low viscosity organic solvent, charge and discharge rate performances and low temperature discharge performance of the lithium-ion secondary battery can be improved, but high temperature performance of the lithium-ion secondary battery normally becomes poor, and the problems of the lithium-ion secondary battery in application cannot be solved perfectly.

### SUMMARY OF THE PRESENT DISCLOSURE

In view of the problems existing in the background, an object of the present disclosure is to provide an electrolyte and a secondary lithium battery, when the electrolyte is applied to the secondary lithium battery, the secondary lithium battery can have excellent high temperature cycle performance, high temperature storage performance, low temperature discharge performance and large rate charging performance at the same time, and low temperature lithium precipitation of the secondary lithium battery can be significantly inhibited.

In order to achieve the above object, in one aspect of the present disclosure, the present disclosure provides an electrolyte, which comprises a lithium salt, an organic solvent and an additive. The additive comprises fluoroborate and lithium difluorophosphate.

In another aspect of the present disclosure, the present disclosure provides an secondary lithium battery, which comprises the electrolyte according to the one aspect of the present disclosure.

Compared to the technologies in the background, the present disclosure has the following beneficial effects: when the electrolyte of the present disclosure is applied to the secondary lithium battery, the secondary lithium battery can have excellent high temperature cycle performance, high temperature storage performance, low temperature discharge performance and large rate charging performance at the same time, and low temperature lithium precipitation of the secondary lithium battery can be significantly inhibited.

### DETAILED DESCRIPTION

Hereinafter an electrolyte and a secondary lithium battery according to the present disclosure will be described in detail.

Firstly, an electrolyte according to a first aspect of the present disclosure will be described.

The electrolyte according to the first aspect of the present disclosure comprises a lithium salt, an organic solvent and an additive. The additive comprises fluoroborate and lithium difluorophosphate (LiPO₂F₂).

In the electrolyte according to the first aspect of the present disclosure, lithium difluorophosphate can improve high temperature cycle performance, high temperature storage performance and low temperature discharge performance of a secondary lithium battery, the reason is that two oxygen atoms in the structure of lithium difluorophosphate can complex with transition metal element of a positive electrode active material, the positive electrode active material will be improved in stability and will be reduced in oxidative activity to the electrolyte, so that high temperature cycle performance of the secondary lithium battery is effectively improved and volume expansion of the secondary lithium battery under high temperature is inhibited. Meanwhile, the interaction of lithium difluorophosphate and the positive electrode active material is beneficial to reduce electrochemical reaction resistance of a positive electrode plate, improve dynamics performance of the positive electrode plate and improve low temperature discharge performance of the secondary lithium battery. However, lithium difluorophosphate will reductively decompose on a negative electrode plate, a decomposition product will cover a surface of the negative electrode plate, resulting in an increase of lithium intercalation resistance of the negative electrode plate, which is not beneficial to large rate charging performance, especially when charging under low temperature environment, and the increased lithium intercalation resistance will probably cause lithium metal to precipitate on the surface of the negative electrode plate, thereby deteriorating low temperature charging performance of the secondary lithium battery. After introducing fluoroborate into the electrolyte containing lithium difluorophosphate, a SEI film having high ionic conductivity can be formed on the surface of the negative electrode plate, which can effectively improve low temperature charging performance and large rate charging performance of the secondary lithium battery. The forming mechanism of the SEI film is explained as follows, but it is not limited thereto. Fluoroborate can preferentially reductively decompose on the surface of the negative electrode plate, which can improve stability of the SEI film and inhibit further reductive decomposition of an organic solvent. Moreover, fluoroborate is a boron-based anion acceptor, which can combine with anion such as F⁻, O₂⁻, O₂²⁻ and the like, promote dissolution of inert constituent such as inorganic salt, for example, LiF, Li₂O, Li₂O₂ and the like, in the SEI film, improve constitution of the SEI film, effectively reduce interface resistance of the negative electrode plate, thus improve low temperature charging performance and large rate charging performance of the secondary lithium battery.

In the electrolyte according to the first aspect of the present disclosure, fluoroborate is one or more selected from a group consisting of compounds represented by formula 1. Where, R₁, R₂ and R₃ each independently are one selected from a group consisting of C1˜C20 alkyl group and C6˜C16 aryl group, and at least one of R₁, R₂ and R₃ makes a hydrogen atom substituted with a fluorine atom.

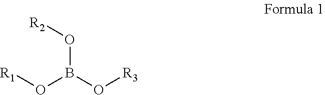

In the electrolyte according to the first aspect of the present disclosure, the C1˜C20 alkyl group may be chain alkyl group or cycle alkyl group. Specifically, the C1˜C20 alkyl group may be one selected from a group consisting of methyl group, ethyl group, n-propyl group, isopropyl group, cyclopropyl group, n-butyl group, isobutyl group, sec-butyl group, tert-butyl group, n-pentyl group, isopentyl group, neo-pentyl group, cyclopentyl group, n-hexyl group, isohexyl group, cyclohexyl group, heptyl group, cycloheptyl group, octyl group, cyclooctyl group, nonyl group, decyl group, undecyl group, dodecyl group, tridecyl group, tetradecyl group, pentadecyl group, hexadecyl group, heptadecyl group, octadecyl group, nonadecyl group and eicosyl group.

In the electrolyte according to the first aspect of the present disclosure, C6˜C16 aryl group may be one selected from a group consisting of phenyl group, benzyl group, biphenylyl group, p-methylphenyl group, o-methylphenyl group, m-methylphenyl group, p-ethylphenyl group, m-ethylphenyl group, o-ethylphenyl group, 3,5-dimethylphenyl group, 2,6-dimethylphenyl group, 3,5-diethylphenyl group, 2,6-diethylphenyl group, 3,5-diisopropylphenyl, 2,6-diisopropylphenyl, 3,5-di-n-propyl phenyl group, 2,6-di-n-propyl phenyl group, 3,5-dibutylphenyl group, 2,6-dibutylphenyl group, 3,5-diisobutylphenyl group, 2,6-diisobutylphenyl group, 3,5-di-tert-butylphenyl group, 2,6-di-tert-butylphenyl group, triphenylmethyl group, 1-naphthyl group and 2-naphthyl group.

In the electrolyte according to the first aspect of the present disclosure, each of R₁, R₂ and R₃ makes the hydrogen atom substituted with the fluorine atom.

In the electrolyte according to the first aspect of the present disclosure, preferably, R₁, R₂ and R₃ are the same.

In the electrolyte according to the first aspect of the present disclosure, fluoroborate is one or more selected from a group consisting of tris(2,2,2-trifluoroethyl) borate (TTFEB), tris(2,2,3,3-tetrafluoropropyl) borate (TTFPB), tris(hexafluoroisopropyl) borate (THFPB) and tris(pentafluorophenyl) borate (TPFPBA).

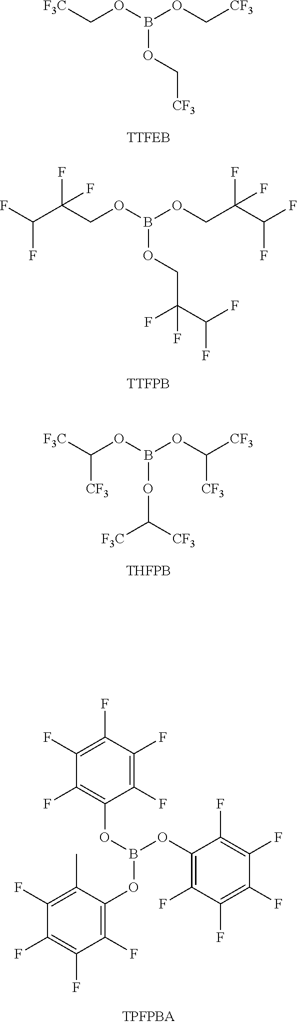 [SMILES: FC(F)(F)COB(OCC(F)(F)F)OCC(F)(F)F ; "THFPB" ; FC(F)C(F)(F)COB(OCC(F)(F)C(F)F)OCC(F)(F)C(F)F ; "TTFPB" ; FC(F)(F)C(OB(OC(C(F)(F)F)C(F)(F)F)OC(C(F)(F)F)C(F)(F)F)C(F)(F)F ; Cc1c(F)c(F)c(F)c(F)c1OB(Oc1c(F)c(F)c(F)c(F)c1F)Oc1c(F)c(F)c(F)c(F)c1F]

In the electrolyte according to the first aspect of the present disclosure, a content of lithium difluorophosphate is 0.1%˜3% of a total mass of the electrolyte. When the content of lithium difluorophosphate is lower than 0.1% of the total mass of the electrolyte, the reaction of forming the passive film having low resistance on the surface of the positive electrode plate is insufficient, so the improvement on performance under high temperature is not obvious; when the content of lithium difluorophosphate is higher than 3% of the total mass of the electrolyte, the film formed on the surface of the negative electrode plate is too thick, and the resistance is significantly increased, which is not beneficial to improve performance of the secondary lithium battery.

In the electrolyte according to the first aspect of the present disclosure, a content of fluoroborate is 0.01%˜5% of the total mass of the electrolyte. When the content of fluoroborate is lower than 0.01% of the total mass of the electrolyte, the modification of SEI film of the negative electrode plate by fluoroborate is not obvious, it cannot effectively reduce interface resistance, and there is no obvious improvement on large rate charging performance and low temperature lithium precipitation; when the content of fluoroborate is higher than 5% of the total mass of the electrolyte, fluoroborate promotes decomposition of the lithium salt, the generated PF₅ will catalyze polymerization of the electrolyte, causing high temperature cycle performance and high temperature storage performance of the secondary lithium battery to be poor.

In the electrolyte according to the first aspect of the present disclosure, the lithium salt is one or more selected from a group consisting of LiPF₆, LiBF₄, LiClO₄, LiAsF₆, LiTFSI, LiTFS, LiFSI, LiDFOB and LiBOB.

In the electrolyte according to the first aspect of the present disclosure, the organic solvent is one or more selected from a group consisting of ethylene carbonate (EC), propylene carbonate (PC), dimethyl carbonate (DMC), diethyl carbonate (DEC), ethyl methyl carbonate (EMC), γ-butyrolactone (BL), methyl formate (MF), ethyl formate (EF), ethyl acetate (EA), ethyl propionate (EP), propyl propionate (PP), dimethyl sulfoxide (DMSO), tetramethylene sulfone (TMSO), methyl sulfonyl mathane (MSM) and tetrahydrofuran (THF).

Next, a secondary lithium battery according to a second aspect of the present disclosure is described.

The secondary lithium battery according to the second aspect of the present disclosure comprises the electrolyte according to the first aspect of the present disclosure.

In the secondary lithium battery according to the second aspect of the present disclosure, the secondary lithium battery further comprises a positive electrode plate, a negative electrode plate, a separator and a package case.

In the secondary lithium battery according to the second aspect of the present disclosure, the secondary lithium battery may be a lithium-ion secondary battery or a lithium-metal secondary battery.

In the secondary lithium battery according to the second aspect of the present disclosure, the positive electrode plate may comprise a positive electrode current collector and a positive electrode film, the positive electrode film is provided on the positive electrode current collector and comprises a positive electrode active material. The positive electrode active material may be selected one or more from a group consisting of lithium cobalt oxide, lithium iron phosphate, lithium manganese oxide, nickel cobalt manganese ternary material and nickel cobalt aluminum ternary material.

In the secondary lithium battery according to the second aspect of the present disclosure, the negative electrode plate may comprises a negative electrode current collector and a negative electrode film, the negative electrode film is provided on the negative electrode current collector and comprises a negative electrode active material. The negative electrode active material may be selected from graphite and/or silicon.

In the secondary lithium battery according to the second aspect of the present disclosure, the negative electrode plate may also directly use lithium metal and its alloy.

In the secondary lithium battery according to the second aspect of the present disclosure, the specific type of the separator is not limited, it may be any separator material used in the prior art, such as a polyethylene film, a polypropylene film, a polyvinylidene fluoride film and a multilayer composite film thereof, but it is not limited thereto.

Hereinafter the present disclosure will be described in detail in combination with examples. It should be noted that, the examples described in the present disclosure are only used for explaining the present disclosure, and are not intended to limit the scope of the present disclosure. Pouch-type lithium-ion secondary battery is selected in the present disclosure to perform related tests.

In the following examples and comparative examples, the materials, reagents and instruments used are commercially available unless otherwise specified.

The lithium-ion secondary batteries of examples 1-17 and comparative examples 1-6 were prepared as follows.

(1) Preparation of a positive electrode plate: LiNi_{0.5}Co_{0.2}Mn_{0.3}O₂ (positive electrode active material), polyvinylidene fluoride (binder), acetylene black (conductive agent) were mixed according a mass ratio of 97:1:2, then 1-methyl-2-pyrrolidinone (NMP) was added, mixing was performed under vacuum mixer until the system became uniform and transparent, a positive electrode slurry was obtained; then the positive electrode slurry was uniformly coated on an aluminum foil (positive electrode current collector) having a thickness of 14 μm; drying under room temperature was then performed, which was followed by moving the aluminum foil to an oven for baking 1 h under 120° C., then after cold-pressing and slitting, the positive electrode plate was obtained.

(2) Preparation of a negative electrode plate: artificial graphite (negative electrode active material), sodium carboxymethylcellulose (thickening agent, CMC), styrene butadiene rubber latex (binder) were mixed according to a mass ratio of 98:1:1, then deionized water was added, a negative electrode slurry was obtained under vacuum mixer; then the positive electrode slurry was uniformly coated on a copper foil (negative electrode current collector) having a thickness of 8 μm; after drying under room temperature, the copper foil was moved to an oven for baking 1 h under 120° C., then after cold-pressing and slitting, the negative electrode plate was obtained.

(3) Preparation of an electrolyte: in an argon atmosphere glove box in which the water content was less than 10 ppm, EC, EMC and DEC according to a mass ratio of EC:EMC:DEC=30:50:20 were mixed as an organic solvent, then fully dried LiPF₆ (lithium salt) was dissolved into the mixed organic solvent, then fluoroborate and lithium difluorophosphate were added, after uniformly mixed, an electrolyte was obtained. Where, a concentration of LiPF₆ was 1 mol/L. A specific type and content of fluoroborate and lithium difluorophosphate used in the electrolyte were shown in table 1, the added amount of fluoroborate and lithium difluorophosphate were mass percentage calculated based on the total mass of the electrolyte.

(4) Preparation of a separator: a polypropylene film with a thickness of 12 μm was used as a separator.

(5) Preparation of a lithium-ion secondary battery: the positive electrode plate, the separator and the negative electrode plate were laminated in order to make the separator separate the positive electrode plate from the negative electrode plate, then were wound to form a square electrode assembly, the square electrode assembly was placed in an aluminum-plastic film, then drying was performed at 80° C. to remove water, and the corresponding electrolyte was injected into the aluminum-plastic film and the aluminum-plastic film was sealed, after standing-by, hot-cold pressing, forming, clamping, capacity grading and the like, the pouch-type lithium-ion secondary battery was obtained.

TABLE 1
Parameters of examples 1-17 and comparative examples 1-6

| | Additive and added amount (%) | | | | |
|---|---|---|---|---|---|
| | Lithium | Fluoroborate | | | |
| | difluorophosphate | THFPB | TTFEB | TTFPB | TPFPBA |
| Example 1 | 1 | 0.05 | / | / | / |
| Example 2 | 1 | 0.5 | / | / | / |
| Example 3 | 1 | 1 | / | / | / |
| Example 4 | 1 | 3 | / | / | / |
| Example 5 | 1 | 5 | / | / | / |
| Example 6 | 0.1 | 1 | / | / | / |
| Example 7 | 0.3 | 1 | / | / | / |
| Example 8 | 0.5 | 1 | / | / | / |
| Example 9 | 2 | 1 | / | / | / |
| Example 10 | 3 | 1 | / | / | / |
| Example 11 | 1 | / | 1 | / | / |
| Example 12 | 1 | / | / | 1 | / |
| Example 13 | 1 | / | / | / | 1 |
| Example 14 | 1 | 0.5 | 0.5 | / | |
| Example 15 | 1 | 0.5 | / | 0.5 | |
| Example 16 | 1 | 0.5 | / | / | 0.5 |
| Example 17 | 1 | 0.5 | 0.2 | 0.3 | |
| Comparative | / | / | / | / | |
| example 1 | | | | | |
| Comparative | 1 | / | / | / | |
| example 2 | | | | | |
| Comparative | / | 1 | / | / | |
| example 3 | | | | | |
| Comparative | 4 | 1 | / | / | |
| example 4 | | | | | |
| Comparative | 1 | 6 | / | / | |
| example 5 | | | | | |
| Comparative | 4 | 6 | / | / | |
| example 6 | | | | | |

Next, test processes of the lithium-ion secondary batteries were described.

(1) Testing of High Temperature Storage Performance of the Lithium-Ion Secondary Battery

At 25° C., after standing-by for 30 minutes, the lithium-ion secondary battery was then charged to a voltage of 4.3V at a constant current of 1 C, then the lithium-ion secondary battery was charged to a current of 0.05 C at a constant voltage of 4.3V, a volume of the lithium-ion secondary battery was tested and marked as V₀; then the fully charged lithium-ion secondary battery was stored under 85° C. in the thermostat, after storing for 10 days, drainage method was used to test the volume and the volume was marked as V₁.

Volume expansion rate of the lithium-ion secondary battery after stored for 10 days under 85° C. (%)=(V₁−V₀)/V₀×100%.

(2) Testing of High Temperature Cycle Performance of the Lithium-Ion Secondary Battery

At 45° C., after standing-by for 30 minutes, the lithium-ion secondary battery was charged to a voltage of 4.3V at a constant current of 3 C, then further charged to a current of 0.05 C at a constant voltage of 4.3V, after standing-by for 5 minutes, the lithium-ion secondary was discharged to a voltage of 2.8V at a constant current of 1 C, this was a charge-discharge cycle, the discharging capacity of the lithium-ion secondary battery at this time was the discharging capacity after first cycle. Charge/discharge test of the lithium-ion secondary battery was performed for 500 times cycles according to the above method.

Capacity retention rate of the lithium-ion secondary battery after cycling for N times under 45° C. (%)=(Discharging capacity after N times cycles/Discharging capacity after first time cycle)×100%.

(3) Testing of Large Rate Charging Performance of the Lithium-Ion Secondary Battery

At 25° C., after standing-by for 30 minutes, the lithium-ion secondary battery was discharged to 2.8V at a constant current of 1 C, after standing-by for 5 minutes, the lithium-ion secondary battery was charged to 4.3V at a constant current of 0.5 C, then after standing-by for 5 minutes, the lithium-ion secondary battery was discharged to 2.8V at a constant current of 2.8V, the charging capacity charged under 0.5 C was obtained.

At 25° C., after standing-by for 30 minutes, the lithium-ion secondary battery was discharged to 2.8V at a constant current of 1 C, after standing-by for 5 minutes, the lithium-ion secondary battery was separately charged to 4.3V at different rates (1 C, 3 C, 5 C), then after standing-by for 5 minutes, the lithium-ion secondary battery was discharged to 2.8V at a constant current of 1 C, charging capacity charged under different rate (1 C, 3 C, 5 C) were obtained.

Charging capacity rate of the lithium-ion secondary battery charged under different rate (%)=Charging capacity charged under different rate (1 C, 3 C, 5 C)/Charging capacity charged under 0.5 C×100%.

(4) Testing of Low Temperature Discharge Performance of the Lithium-Ion Secondary Battery

At 25° C., after standing-by for 30 minutes, the lithium-ion secondary battery was charged to a voltage of 4.3V at a constant current of 1 C, then further charged to a current of 0.05 C at a constant voltage of 4.3V, after standing-by for 5 minutes, the lithium-ion secondary battery was stand-by for 4 hours respectively under different temperature (25° C., 0° C., −10° C.), then the lithium-ion secondary battery was discharged to 2.8V at a constant current of 1 C, after discharging, standing-by was performed for 5 minutes, discharging capacity of the lithium-ion secondary battery at this time was marked.

Discharging capacity rate of the lithium-ion secondary battery under different temperature (%)=(Discharging capacity under 0° C., −10° C.)/(Discharging capacity under 25° C.)×100%.

(5) Testing of Lithium Precipitation Performance of the Negative Electrode Plate

At 25° C., after standing-by for 30 minutes, the lithium-ion secondary battery was charged to a voltage of 4.3V at a constant current of 5 C, then further charged to a current of 0.05 C at a constant voltage of 4.3V, after standing-by for 5 minutes, the lithium-ion secondary battery was discharged to a voltage of 2.8V at a constant current of 1 C, this was a charge-discharge cycle, the lithium-ion secondary battery was cycled 10 times according to the above process, then the lithium-ion secondary battery was charged to a voltage of 4.3V at a constant current of 5 C. In a desiccation room environment, the lithium-ion secondary battery charged to 4.3V was disassembled, and the lithium precipitated on the surface of the negative electrode plate was observed. Where, the degree of the lithium precipitation was divided into no lithium precipitation, slight lithium precipitation, moderate lithium precipitation and serious lithium precipitation. The slight lithium precipitation indicated that the area of the lithium precipitation on the surface of the negative electrode was one-tenth or less of the entire area of the surface of the negative electrode plate, serious lithium precipitation indicated that the area of the lithium precipitation on the surface of the negative electrode plate was more than one-third of the entire area of the surface of the negative electrode plate.

TABLE 2
Test results of examples 1-17 and comparative examples 1-6

| | Capacity | | | Volume | | | | | | |
|---|---|---|---|---|---|---|---|---|---|---|
| | retention rate | | | expansion | Discharging | | | | | Lithium |
| | after cycling | | | rate after | capacity rate | | Charged capacity | | | precipitation |
| | for N times | | | stored for 10 | under different | | rate charged under | | | performance of |
| | under 45° C./% | | | days under | temperature/% | | different rate/% | | | the negative |
| | 300 | 800 | 1500 | 85° C./% | 0° C. | −10° C. | 1 C | 3 C | 5 C | electrode plate |
| Example 1 | 95.2 | 90.1 | 83.3 | 23.5 | 93.7 | 81.9 | 97.1 | 84.3 | 71.6 | Moderate |
| | | | | | | | | | | lithium |
| | | | | | | | | | | precipitation |
| Example 2 | 94.8 | 89.6 | 82.3 | 24.9 | 94.0 | 81.3 | 97.6 | 88.3 | 76.2 | Slight lithium |
| | | | | | | | | | | precipitation |
| Example 3 | 94.3 | 89.0 | 81.3 | 26.2 | 93.5 | 80.2 | 97.5 | 89.6 | 80.2 | No lithium |
| | | | | | | | | | | precipitation |
| Example 4 | 93.2 | 87.8 | 79.6 | 30.7 | 93.6 | 83.1 | 97.4 | 92.3 | 83.4 | No lithium |
| | | | | | | | | | | precipitation |
| Example 5 | 90.5 | 85.4 | 75.4 | 54.4 | 93.5 | 82.4 | 96.3 | 94.5 | 85.6 | No lithium |
| | | | | | | | | | | precipitation |
| Example 6 | 93.3 | 76.4 | 66.3 | 67.5 | 90.2 | 76.5 | 98.0 | 91.0 | 83.1 | No lithium |
| | | | | | | | | | | precipitation |
| Example 7 | 93.5 | 80.4 | 72.7 | 45.2 | 91.5 | 80.3 | 97.9 | 90.6 | 82.5 | No lithium |
| | | | | | | | | | | precipitation |
| Example 8 | 94.0 | 84.4 | 77.3 | 34.2 | 92.4 | 81.4 | 97.7 | 90.2 | 81.9 | No lithium |
| | | | | | | | | | | precipitation |
| Example 9 | 93.1 | 83.4 | 72.0 | 19.4 | 88.6 | 78.4 | 96.3 | 80.5 | 73.0 | Slight lithium |
| | | | | | | | | | | precipitation |
| Example 10 | 90.8 | 78.9 | 68.3 | 17.4 | 87.5 | 75.3 | 95.4 | 79.7 | 69.5 | Slight lithium |
| | | | | | | | | | | precipitation |
| Example 11 | 94.6 | 91.2 | 83.4 | 28.4 | 93.2 | 78.5 | 97.5 | 91.3 | 83.2 | No lithium |
| | | | | | | | | | | precipitation |
| Example 12 | 95.2 | 89.8 | 83.6 | 26.3 | 94.3 | 81.4 | 97.3 | 90.7 | 82.1 | No lithium |
| | | | | | | | | | | precipitation |
| Example 13 | 95.5 | 90.1 | 84.0 | 28.4 | 95.0 | 82.4 | 98.5 | 91.4 | 84.3 | No lithium |
| | | | | | | | | | | precipitation |
| Example 14 | 95.4 | 90.5 | 82.8 | 27.5 | 92.7 | 80.8 | 98.6 | 91.5 | 81.9 | No lithium |
| | | | | | | | | | | precipitation |
| Example 15 | 95.3 | 91.4 | 93.2 | 30.4 | 92.5 | 78.4 | 96.5 | 92.0 | 80.6 | No lithium |
| | | | | | | | | | | precipitation |
| Example 16 | 95.0 | 91.6 | 85.2 | 26.2 | 94.3 | 79.9 | 97.3 | 92.2 | 80.9 | No lithium |
| | | | | | | | | | | precipitation |
| Example 17 | 94.7 | 89.8 | 81.6 | 28.2 | 94.0 | 82.4 | 97.5 | 91.4 | 82.5 | No lithium |
| | | | | | | | | | | precipitation |
| Comparative | 94.2 | 75.1 | 60.3 | 83.3 | 88.6 | 70.5 | 97.7 | 86.8 | 76.9 | Slight lithium |
| example 1 | | | | | | | | | | precipitation |
| Comparative | 95.3 | 90.2 | 83.4 | 23.5 | 93.4 | 80.3 | 95.4 | 83.4 | 71.2 | Serious lithium |
| example 2 | | | | | | | | | | precipitation |
| Comparative | 93.1 | 70.4 | 53.2 | 90.1 | 88.1 | 73.9 | 98 | 91.3 | 83.4 | No lithium |
| example 3 | | | | | | | | | | precipitation |
| Comparative | 90.1 | 74.5 | 62.3 | 15.2 | 85.2 | 75.0 | 94.2 | 76.4 | 65.2 | Serious lithium |
| example 4 | | | | | | | | | | precipitation |
| Comparative | 82.4 | 73.2 | 48.9 | 65.4 | 93.5 | 81.4 | 95.3 | 93.4 | 84.6 | No lithium |
| example 5 | | | | | | | | | | precipitation |
| Comparative | 89.9 | 81.3 | 57.2 | 43.5 | 84.3 | 67.4 | 94.4 | 87.5 | 80.2 | Serious lithium |
| example 6 | | | | | | | | | | precipitation |

From the comparison of the comparative examples 1-2, it could be seen that when lithium difluorophosphate was added into the electrolyte, high temperature cycle performance and high temperature storage performance of the lithium-ion secondary battery were significantly improved, and low temperature discharge performance of the lithium-ion secondary battery was improved to a large extent, but large rate charging performance and low temperature lithium precipitation of the lithium-ion secondary battery were significantly deteriorated. From the comparison of the comparative example 1 and comparative example 3, it could be seen that when tris(hexafluoroisopropyl) borate was added into the electrolyte, large rate charging performance and low temperature lithium precipitation of the lithium-ion secondary battery were significantly improved, but high temperature cycle performance and high temperature storage performance of the lithium-ion secondary battery were deteriorated. Lithium difluorophosphate and fluoroborate were added into the electrolyte at the same time in examples 1-17, lithium-ion secondary battery had excellent high temperature cycle performance, high temperature storage performance, low temperature discharge performance and large rate charging performance at the same time, and low temperature lithium precipitation of the lithium-ion secondary battery was significantly inhibited.

In comparative examples 4-6, that the content of fluoroborate and/or lithium difluorophosphate were/was too high all would deteriorate performances of lithium-ion secondary battery.

According to the disclosure of the above description, those skilled in the art may also make an appropriate change and modification to the above examples. Therefore, the present disclosure is not limited to the specific examples disclosed and described above, and some modifications and change to the present disclosure should also fall within the scope of protection of the Claims of the present disclosure.

What is claimed is:

1. An electrolyte, comprising:
a lithium salt;
an organic solvent; and
an additive;
wherein,
the additive comprises fluoroborate and lithium difluorophosphate.

2. The electrolyte according to claim 1, wherein fluoroborate is one or more selected from a group consisting of compounds represented by formula 1; 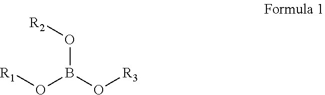
Where, R₁, R₂ and R₃ each independently are one selected from a group consisting of C1˜C20 alkyl group and C6˜C16 aryl group, and at least one of R₁, R₂ and R₃ makes a hydrogen atom substituted with a fluorine atom.

3. The electrolyte according to claim 2, wherein
the C1˜C20 alkyl group is one selected from a group consisting of methyl group, ethyl group, n-propyl group, isopropyl group, cyclopropyl group, n-butyl group, isobutyl group, sec-butyl group, tert-butyl group, n-pentyl group, isopentyl group, neo-pentyl group, cyclopentyl group, n-hexyl group, isohexyl group, cyclohexyl group, heptyl group, cycloheptyl group, octyl group, cyclooctyl group, nonyl group, decyl group, undecyl group, dodecyl group, tridecyl group, tetradecyl group, pentadecyl group, hexadecyl group, heptadecyl group, octadecyl group, nonadecyl group and eicosyl group;
the C6˜C16 aryl group is one selected from a group consisting of phenyl group, benzyl group, biphenylyl group, p-methylphenyl group, o-methylphenyl group, m-methylphenyl group, p-ethylphenyl group, m-ethylphenyl group, o-ethylphenyl group, 3,5-dimethylphenyl group, 2,6-dimethylphenyl group, 3,5-diethylphenyl group, 2,6-diethylphenyl group, 3,5-diisopropylphenyl, 2,6-diisopropylphenyl, 3,5-di-n-propyl phenyl group, 2,6-di-n-propyl phenyl group, 3,5-dibutylphenyl group, 2,6-dibutylphenyl group, 3,5-diisobutylphenyl group, 2,6-diisobutylphenyl group, 3,5-di-tert-butylphenyl group, 2,6-di-tert-butylphenyl group, triphenylmethyl group, 1-naphthyl group and 2-naphthyl group.

4. The electrolyte according to claim 2, wherein each of R₁, R₂ and R₃ makes the hydrogen atom substituted with the fluorine atom.

5. The electrolyte according to claim 2, wherein R₁, R₂ and R₃ are the same.

6. The electrolyte according to claim 4, wherein R₁, R₂ and R₃ are the same

7. The electrolyte according to claim 4, wherein fluoroborate is one or more selected from a group consisting of tris(2,2,2-trifluoroethyl) borate, tris(2,2,3,3-tetrafluoropropyl) borate, tris(hexafluoroisopropyl) borate and tris(pentafluorophenyl) borate.

8. The electrolyte according to claim 1, wherein
a content of lithium difluorophosphate is 0.1%˜3% of a total mass of the electrolyte;
a content of fluoroborate is 0.01%˜5% of the total mass of the electrolyte.

9. The electrolyte according to claim 1, wherein the lithium salt is one or more selected from a group consisting of LiPF6, LiBF4, LiClO4, LiAsF6, LiTFSI, LiTFS, LiFSI, LiDFOB and LiBOB.

10. The electrolyte according to claim 1, wherein the organic solvent is one or more selected from a group consisting of ethylene carbonate, propylene carbonate, dimethyl carbonate, diethyl carbonate, ethyl methyl carbonate, γ-butyrolactone, methyl formate, ethyl formate, ethyl acetate, ethyl propionate, propyl propionate, dimethyl sulfoxide, tetramethylene sulfone, methyl sulfonyl mathane and tetrahydrofuran.

11. A secondary lithium battery, comprising an electrolyte,
wherein,
the electrolyte comprises a lithium salt, an organic solvent and an additive, the additive comprises fluoroborate and lithium difluorophosphate.

12. The secondary lithium battery according to claim 11, wherein fluoroborate is one or more selected from a group consisting of compounds represented by formula 1; 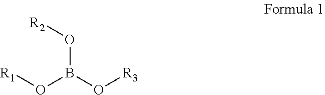
Where, R₁, R₂ and R₃ each independently are one selected from a group consisting of C1˜C20 alkyl group and C6˜C16 aryl group, and at least one of R₁, R₂ and R₃ makes a hydrogen atom substituted with a fluorine atom.

13. The secondary lithium battery according to claim 12, wherein
the C1˜C20 alkyl group is one selected from a group consisting of methyl group, ethyl group, n-propyl group, isopropyl group, cyclopropyl group, n-butyl group, isobutyl group, sec-butyl group, tert-butyl group, n-pentyl group, isopentyl group, neo-pentyl group, cyclopentyl group, n-hexyl group, isohexyl group, cyclohexyl group, heptyl group, cycloheptyl group, octyl group, cyclooctyl group, nonyl group, decyl group, undecyl group, dodecyl group, tridecyl group, tetradecyl group, pentadecyl group, hexadecyl group, heptadecyl group, octadecyl group, nonadecyl group and eicosyl group;
the C6˜C16 aryl group is one selected from a group consisting of phenyl group, benzyl group, biphenylyl group, p-methylphenyl group, o-methylphenyl group, m-methylphenyl group, p-ethylphenyl group, m-ethylphenyl group, o-ethylphenyl group, 3,5-dimethylphenyl group, 2,6-dimethylphenyl group, 3,5-diethylphenyl group, 2,6-diethylphenyl group, 3,5-diisopropylphenyl, 2,6-diisopropylphenyl, 3,5-di-n-propyl phenyl group, 2,6-di-n-propyl phenyl group, 3,5-dibutylphenyl group, 2,6-dibutylphenyl group, 3,5-diisobutylphenyl group, 2,6-diisobutylphenyl group, 3,5-di-tert-butylphenyl group, 2,6-di-tert-butylphenyl group, triphenylmethyl group, 1-naphthyl group and 2-naphthyl group.

14. The secondary lithium battery according to claim 12, wherein each of R₁, R₂ and R₃ makes the hydrogen atom substituted with the fluorine atom.

15. The secondary lithium battery according to claim 12, wherein R₁, R₂ and R₃ are the same.

16. The secondary lithium battery according to claim 14, wherein R₁, R₂ and R₃ are the same.

17. The secondary lithium battery according to claim 14, wherein fluoroborate is one or more selected from a group consisting of tris(2,2,2-trifluoroethyl) borate, tris(2,2,3,3-tetrafluoropropyl) borate, tris(hexafluoroisopropyl) borate and tris(pentafluorophenyl) borate.

18. The secondary lithium battery according to claim 11, wherein
a content of lithium difluorophosphate is 0.1%˜3% of a total mass of the electrolyte;
a content of fluoroborate is 0.01%˜5% of the total mass of the electrolyte.

19. The secondary lithium battery according to claim 11, wherein the lithium salt is one or more selected from a group consisting of LiPF6, LiBF4, LiClO4, LiAsF6, LiTFSI, LiTFS, LiFSI, LiDFOB and LiBOB.

20. The secondary lithium battery according to claim 11, wherein the organic solvent is one or more selected from a group consisting of ethylene carbonate, propylene carbonate, dimethyl carbonate, diethyl carbonate, ethyl methyl carbonate, γ-butyrolactone, methyl formate, ethyl formate, ethyl acetate, ethyl propionate, propyl propionate, dimethyl sulfoxide, tetramethylene sulfone, methyl sulfonyl mathane and tetrahydrofuran.
